(19) United States
(12) Patent Application Publication
(10) Pub. No.: US 2005/0001027 A1
(43) Pub. Date: Jan. 6, 2005

(54) Integrated cards

(76) Inventor: Bamdad Bahar, Chester, MD (US)

Correspondence Address: BAMDAD BAHAR, 809 NORMAN ESBRIDGE HIGHWAY, SEAFORD, DE, 19947, US

(21) Appl. No.: 10/611,904

(22) Filed: Jul. 3, 2003

(51) Int. Cl. G06K 5/00

(52) U.S. Cl. 235/382

(57) ABSTRACT

The present invention is in the field of integrated card technologies, and more specifically the present invention is in the field of multi function smart cards and other types of information containing cards.

### FIELD OF THE INVENTION

The present invention is in the field of integrated card technologies, and more specifically the present invention is in the field of multi function smart cards and other types of information containing cards.

### BACKGROUND

Smart cards and other information containing cards are currently being used for various purposes in many different areas of commerce. Smart card technology has been improving at an impressive rate, allowing an ever increasing amount of information to be conveniently stored on a single card. Throughout the economy, smart cards are used to store information specific to the user of the card, thereby allowing services to be specifically designed to suit the needs of a particular customer.

Despite the wide area of potential applications for smart cards, usage has been restricted, for example, to coinless laundry facilities and security systems. Other applications, such as telecommunication, remain restricted in the United States. Wide usage for credit card applications has been limited to a few card suppliers utilizing very limited features of smart card technology.

Coinless laundry facilities that use Smart Cards typically utilize “value transfer machines.” These machines dispense smart cards, and are subsequently used for electronic transfer of value to the smart card from a cash bill such as a $1, $5, $10 or $20 bill. The machine contains a cash acceptance unit that reads the bills and then transfers the value to a chip embedded in the smart card. The smart card effectively acts as an electronic purse.

For security type applications, smart cards can be custom printed with or without identification photography and encoded with identification information, which is then read by a card reader to, for example, allow access to services at a secure facility or a membership based service such as a bank or club.

Unfortunately, the advent of smart card technology, as well as other cards used for services, has led to an ever-increasing number of cards in the wallet or purse of the average consumer, with for example one card for laundry, another card or cards for credit services, another card or cards for telecommunication services, and yet another card for security or membership of a service provider. This increase is undesirable because it forces consumers to maintain a cumbersome number of cards and/or accounts.

What are needed in the art are cards and methods that are more efficient to use than those conventionally available.

### SUMMARY OF THE INVENTION

The present invention is in the field of integrated card technologies, and more specifically the present invention is in the field of multi function smart cards and other types of information containing cards.

The present invention includes a method of providing services using a card, comprising: providing said card to a customer; providing laundry facilities to said customer, wherein said card can be used to pay for use of said laundry facilities; and, providing a telephone service to said customer, wherein said card can be used to pay for use of said telephone service.

The present invention includes a method for a consumer to use a card, comprising: obtaining said card; adding value to said card; using said card to purchase laundry facility goods and services; and, using said card to purchase a telephone service.

The present invention includes a card, comprising: means for allowing a user of said card to electronically purchase laundry facility goods and services; and, means for allowing said user to purchase a telephone service.

### DETAILED DESCRIPTION

The present invention is in the field of integrated card technologies, and more specifically the present invention is in the field of multi function smart cards and other types of information containing cards, and methods of using the same. In one embodiment, the present invention includes a smart card, comprising: a means for retrievably storing information that can be modified, wherein said information comprises smart card value information; a means for allowing a user of said smart card to use said value to electronically purchase laundry facility goods and services; a means for visually identifying a user of said smart card; and, a means for allowing said user to use said value to electronically pay bills.

As used herein, a “smart card” means any card suitable for carrying in a wallet or purse, on a keychain, or otherwise is readily carried with a person, to which digital information can be written, stored, retrieved, and modified by using a memory device that is a component of the smart card. Smart card technology is generally known in the art and includes smart cards that have memory devices to which information can be written. These cards are sometimes referred to in the art as “memory cards”. For example, a smart card can include a card with random access memory. Any suitable rewritable memory can be used. In one embodiment, the memory is electrically erasable, programmable read-only memory, or EEPROM. EEPROM has the advantage of not requiring a power source to maintain information over time, for example up to ten years.

Conventional smart cards that can be modified to prepare a smart card of the present invention include those manufactured by ESD Inc. (Pennsylvania), Schlumberger Corp. (New Jersey), and GEMPLUS (Pennsylvania). IC chips for smart cards can be purchased, for example, from manufacturers such as Atmel (San Jose, Calif.).

In various embodiments of the present invention, smart cards include cards that have, in addition to the ability to have information written, stored, retrieved, and modified via a memory device, a microprocessor. The microprocessor can be included in the card as a component on an integrated circuit (IC) chip that can also comprise a memory device. In one embodiment, the memory device and the microprocessor are disposed on the same IC chip. In another embodiment, the memory device and the microprocessor are disposed on different IC chips.

The microprocessor can be any that are known in that art that are suitable for such a use, and can function to perform any desired manipulation. For example, the device that recognizes the smart card, known as a “card acceptance device” or “CAD”, does not have to itself have a microprocessor that is capable of writing information to the smart card, but rather can simply send a signal to the smart card that is processed by the microprocessor in the smart card, with any appropriate smart card information modification made by the microprocessor. In this manner, it is possible to configure a smart card and CAD system that either processes information directly, within a smart card on a microprocessor, or processes information externally to the smart card. In either case a memory device on the smart card can be written to in order to modify the information stored therein.

In one embodiment of the present invention, the smart card comprises plastic, such as polyvinyl chloride, and is approximately the size of a standard credit card embedded with an electronic processor. In various embodiments of smart cards of the present invention, IC chip, memory device, and microprocessor components are all configured within the international standard for power supply voltage, reset default, clock signal, ground, write voltage (VPP), and I/O line.

Smart cards of the present invention can be configured in any conventional way to interact with CADs. As used herein, a “CAD” means any device that is capable of exchanging information with the smart card. In one embodiment, a CAD is a card reader that is disposed in direct physical contact with the smart card. In another embodiment, the CAD does not need to directly contact the smart card, but rather uses radio signals to exchange information with the smart card. In various embodiments of the present invention, smart cards comprise a means for transmitting and receiving radio signals to a CAD, which include any devices conventionally used to transmit and receive such signals. In other embodiments, smart cards of the present invention comprise contacts that can be used to physically connect with CADs and exchange information.

As used herein, “means for retrievably storing information that can be modified” include any appropriate memory device, such as ram, and specifically, EEPROM. The information that is stored on the smart card can include virtually any information that is desired. In one embodiment, the information comprises smart card value information. As used herein, “smart card value information” can be any information that indicates how much purchasing value is present on the card. Purchasing value can be represented by dollars, tokens, vouchers, and other similar types of value representation devices. In one embodiment, a user can add value to a smart card by using a device that will accept any form of currency, including cash, credit card, check, debit card, for example and among others. The device accepts the currency from the user and adds the equivalent amount of value to the smart card. In other embodiments, smart cards are purchased with an initial sum of currency and have a particular starting value. This starting value will be stored in the memory device of the smart card as value information. In various embodiments of the present invention, smart card users can add value to the smart card in any suitable manner, and the value added can be equivalent to or not equivalent to the currency exchanged. In one embodiment, smart card value will be increased equivalently to the amount of currency exchanged by a user.

As used herein, “means for allowing a user” to “purchase” a thing, include anything that allows smart card to be used to buy goods or a service. These means include information temporarily or permanently (such as ROM) stored in the memory device or microprocessor of the smart card in conjunction with a device that allows communication with a CAD designed to authorize the purchase of the thing, such as a radio transmitter and receiver or contacts on the smart card, among other means. In one embodiment, a means for allowing a user of the smart card to use the value on the smart card comprises the memory device with information, optionally a microprocessor, and contacts that can interact with a CAD. In one embodiment, the means for allowing a user of the smart card to use the value on the smart card is used to purchase laundry facility usage. As used herein, “laundry facility goods and services” means any goods or services connected with a laundry facility, including washing machine and dryer time, and vending machines.

As used herein, “means for visually identifying a user” of a smart card includes, any image, whether in digital form or in the form of a picture, that can be used to identify a carrier of a smart card as the person to whom the value on the card belongs. Means for visually identifying a user can include pictures such as photographic images and simulations formed on the surface of the smart card by any conventional method, holographic images, water marks, and combinations of the foregoing, among others. Means for visually identifying a user can also include images that are stored in the form of digital information on the smart card, for example as JPEG, TIFF, Bitmap, or GIF images, among others. Such elements may be printed on the card utilizing smart card printers such as those made by Fargo (N. Dak.). Additionally, software to retain and organize said data may be customized from database software such as Microsoft Access®.

As used herein, “means for allowing said user to use said value to electronically pay bills” includes any of the means given above to purchase goods and services, but with the proper information for bill paying. For example, information stored on the smart card can include account number information and information that allows a user to electronically pay bills to third parties not owned or controlled by the company at which the bill paying service is offered. Such means may optionally include any standard coding or security features, including, but not limited to, bar codes, magnetic stripe codes, anti-tamper signature lines, holographic images, digital encoding and encryption technology, and optical laser readable codes.

The present invention also includes, in addition to the smart cards described herein elsewhere, methods of making, encoding, and using any of the smart cards of the present invention. In any of the cards or methods of the present invention, value can be added to the card at any time, thereby allowing a user to obtain and maintain a single smart card over time.

Specifically, the present invention includes and provides a method of making a smart card comprising manufacturing a smart card having the properties of any of the smart card embodiments described herein.

The present invention also includes a method of encoding a smart card, comprising storing information in the memory device component of any of the smart card embodiments described herein.

The present invention also includes a method of using a smart card, comprising adding value to any of the smart card embodiments described herein.

The present invention also includes a method of using a smart card, comprising using any of the smart card embodiments described herein to purchase goods or services, to use as identification, and/or to pay bills.

The identification properties of the smart cards of the present invention can be used for any additional purpose as well, for example to allow a smart card customer to purchase a money order, to access a money transfer service, to access another financial transaction, or access a secure facility or represent the customer as a member of an organization.

In one embodiment, the present invention includes a method of providing service using a smart card, comprising: providing a smart card to a customer, wherein said customer can add value to said smart card; providing laundry facilities to said customer, wherein said smart card can be used to pay for use of said laundry facilities; and, providing a check cashing service to said customer, wherein said smart card can be used to identify said customer prior to said providing said check cashing service.

This method allows a service provider to offer customers an integrated smart card that allows the customer to use a single card for both purchasing laundry services and identification for check cashing. The need to carry two different cards is therefore obviated.

In another embodiment of a method of the present invention, the above method further includes providing a bill paying service to the customer where the same smart card can be used by the customer to pay bills. In one embodiment, the customer can add value to the smart card and use the value added to directly, electronically pay bills. The payment can be effected automatically, with an automated CAD automatically reducing the value of the card and electronically transferring the funds to a designated payee. In another embodiment, the smart card can be used to directly pay the issuer of the smart card, who then pays the designated payee. In either case the value information stored on the smart card can be updated to indicate a debit against the value of the smart card prior to the transaction. These embodiments allow the smart card user to combine three functions on a single smart card, again obviating the need to carry multiple cards.

In a further embodiment of the present invention, a method for a consumer to use a smart card is provided, comprising: obtaining the smart card; adding value to the smart card; using the smart card to purchase laundry facility goods and services; and, using the smart card to identify the consumer in order to cash a check. As above, this method allows a consumer to combine multiple functions on an integrated smart card. In a further embodiment, the consumer can also use the smart card to pay bills, as described above.

In yet a further embodiment of the present invention, a method for a consumer to use a smart card is provided, comprising: obtaining the smart card; adding value to the smart card; using the smart card to purchase goods and services; using the smart card to identify the consumer in order to cash a check; and using the smart card to pre-pay a telecommunication service, as described above. This is especially favorable for placement of long-distance phone calls. Users typically carry multiple cards in order to either ensure they have sufficient embedded value to be able to make numerous calls beyond the value embedded in one pre-paid phone cards or to have the right card for the right country. Many brands of pre-paid phone cards are discarded after use. With smart cards and methods of the present invention, a user's service can be customized to the user's specific needs.

In one embodiment, information on a magnetic stripe or the information stored in the memory device on the smart card can be read, and the information on the smart card (memory device or magnetic stripe, for example) can then be transmitted to a service with value and custom service requirements to update the account related to that specific user's card.

For example, for a long distance call service, a magnetic stripe can be read, an operator can punch in a specific code for the service being recharged or purchased along with the value being added to the account. The account can then be updated in order to allow the user to make additional long distance calls. Other services beyond telecommunications may be accessed as well, such as roadside assistance services, medical services, and lodging services, among others. In an alternative embodiment in which value is added for a service or bills are paid, the process can be done automatically with a CAD and/or a network, and does not require an operator.

The present invention allows a consumer to combine multiple functions on a smart card. This invention specifically involves a single card with integrated capabilities. Since different services engage different technological infrastructures, this invention presumes a single card may involve multiple elements that will enable different uses.

Various services may be accessed via different referencing mechanisms embedded on or within the card. For example a bar code may be used to provide information regarding the specific service being purchased, and access phone numbers and instructions may be printed with scratch-off pin numbers placed on the card to allow for another service to be accessed.

Further, because of the multiple functionality, the single card can have high frequency usage. Card qualities can be provided to enhance the durability and maintain the reliability of the card. Such qualities can include the use of a high density, high cursivity (hi-c coating) or a high quality magnetic stripe, the use of a high adhesive bonding mechanism at the base of the chip to make a strong (non-breakable), connection to the PVC base under the chip, the elimination of brittle interconnects between the chip and the metal connectors used to contact a reader, selection of a suitably thick (ideally 3 mm but for instance greater than 1.5 mm) PVC card stock to a strong durable card, the use of an over-laminate on the printed surface to protect the printed information on the card (with a window for through contact to the chip connectors), and other elements which may be obvious to one skilled in, the art.

The present invention also includes systems capable of using the smart cards of the present invention and facilitating the performance of the methods described herein. Specifically, a system employing one or more CADs connected to one or more machines or computer networks is included.

The methods of the present invention also include the methods described above using one or more information storage features of a card. In these embodiments, the information stored on the card that is used to perform the methods can be encoded by one or more of the following techniques: magnetic stripe, printing on the card, and smart card technology. Printing includes bar codes and other optically readable codes. Any of the methods given herein elsewhere that use a smart card, where suitable, can also use a card having either or both of the magnetic stripe or printing information in place of the smart card technology.

The present invention includes a method of providing services using a card, comprising: providing said card to a customer; providing laundry facilities to said customer, wherein said card can be used to pay for use of said laundry facilities; and, providing a telephone service to said customer, wherein said card can be used to pay for use of said telephone service.

As used herein, “telephone service” means any telecommunications service that is generally purchased by consumers, including, for example, long distance service.

The present invention includes a method for a consumer to use a card, comprising: obtaining said card; adding value to said card; using said card to purchase laundry facility goods and services; and, using said card to purchase a telephone service.

Adding value to a card that does not have memory on it can be accomplished by storing value information outside of the card, for example in a CAD or in memory located on a network.

The present invention includes a card, comprising: means for allowing a user of said card to electronically purchase laundry facility goods and services; and, means for allowing said user to purchase a telephone service.

In the embodiments just described, the card can have multiple information devices, including smart card, magnetic stripe, and printed information. Any one of these devices can be used to desired information.

Permutations of the present invention include methods in which a card is used to purchase laundry facility goods and services and telephone services and one or more other services. Further services can be added to the card, including for example and without limitation, purchase of vending goods other than laundry goods, purchase of amusements, such as game machines, use of a financial service, use to complete a financial transaction, use to access a secure facility, use for identification for security or check cashing, and use for bill payment services.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

Any document or publication cited hereinabove is hereby incorporated by reference in its entirety.

1. A method of providing services using a card, comprising:
providing said card to a customer;
providing laundry facilities to said customer, wherein said card can be used to pay for use of said laundry facilities; and,
providing a telephone service to said customer, wherein said card can be used to pay for use of said telephone service.

2. The method of claim 1, further comprising providing a check cashing service to said customer, wherein said card can be used to identify said customer prior to said providing said check cashing service.

3. The method of claim 1, further comprising providing a bill paying service to said customer, wherein said card can be used by said customer to pay bills.

4. The method of claim 3, wherein said customer can pay said bills electronically with said card with an electronic find transfer.

5. The method of claim 1, wherein said card is a smart card.

6. The method of claim 1, wherein said card comprises a bar code.

7. The method of claim 1, wherein said card comprises a magnetic stripe.

8. The method of claim 1, wherein said card comprises a photographic image of said customer.

9. The method of claim 1, wherein said laundry facilities can be paid for with said card by contacting said card with a card acceptance device.

10. The method of claim 1, wherein said telephone service comprises long distance charges.

11-20. (cancelled)

21. A method of providing services using a card, comprising:
providing said card to a customer, wherein said card has high durability;
providing laundry facilities to said customer, wherein said card can be used to pay for use of said laundry facilities; and,
providing a telephone service to said customer, wherein said card can be used to pay for use of said telephone service.

22. The method of claim 21, wherein said card comprises an overlaminate.

23. The method of claim 21, wherein said overlaminate defines a window.

24. The method of claim 21, wherein said card comprises a high density magnetic, high cursivity magnetic stripe.

25. The method of claim 21, wherein said card comprises a high quality magnetic stripe.

26. The method of claim 21, wherein said card comprises a high adhesive bonding between a chip and said card.

27. The method of claim 21, wherein said card comprises PVC having a thickness of at least 1.5 millimeters.

28. The method of claim 21, wherein said card comprises PVC having a thickness of at least 3.0 millimeters.

29. The method of claim 21, wherein said card comprises one or more durability characteristics selected from the group consisting of an overlaminate, a high density magnetic, high cursivity magnetic stripe, a high quality magnetic stripe, a high adhesive bonding between a chip and said card, PVC having a thickness of at least 1.5 millimeters, and PVC having a thickness of at least 3.0 millimeters.

30. The method of claim 29, wherein said card comprises the durability characteristics of an overlaminate and PVC having a thickness of at least 1.5 millimeters.
